(19) United States
(12) Patent Application Publication
(10) Pub. No.: US 2008/0241342 A1
(43) Pub. Date: Oct. 2, 2008

(54) Heat Resistant Confectionery

(76) Inventors: Stephen M. Pearson, Hohenbrunn (DE); Salomeja Karobliene, Kaunas (LT); Jolita Skurkiene, Kaunas (LT); Imola Zsigmond, Neubiberg (DE)

Correspondence Address: FITCH EVEN TABIN & FLANNERY, 120 S. LASALLE STREET, SUITE 1600, CHICAGO, IL, 60603-3406, US

(21) Appl. No.: 12/106,833

(22) Filed: Apr. 21, 2008

Related U.S. Application Data
(63) Continuation-in-part of application No. PCT/US2006/038414, filed on Sep. 28, 2006.

(30) Foreign Application Priority Data
Oct. 21, 2005 (EP) 05023014.3

(51) Int. Cl. A23D 7/005

(52) U.S. Cl. 426/601

(57) ABSTRACT

The present invention provides a confectionery product, a component of the confectionery product, or a coating for the confectionery comprising cocoa butter improver (CBI) at 50% by weight or more of added vegetable fat, its use for coating, moulding or preparing confectionery products, and a method for its production.

This application is a Continuation-In-Part of prior International Application Number PCT/US2006/038414, filed Sep. 28, 2006, which claims the benefit of EP 05023014.3, filed Oct. 21, 2005, both of which are hereby incorporated herein by reference in their entirety.

### FIELD OF INVENTION

The present invention concerns the use of a high proportion of CBI (cocoa butter improver) in the manufacture of confectionery products to provide improved heat resistance.

### BACKGROUND OF THE INVENTION

In Europe, under the European Union (EU) Chocolate Directive 2000/36/EC, six vegetable fats are allowed to be used in chocolate beside cocoa butter: palm oil, illipé, shea, kokum, mango kernel and sal. The selection of these fats is based on their triacylglycerol compositions. The permitted fats must be rich in the three symmetrical mono-unsaturated triacylglycerols of the type POP, POS and SOS (O=oleic acid, P=palmitic acid, and S=stearic acid). The typical content of symmetrical mono-unsaturated triacylglycerols in each of the six fats permitted for use in chocolate under EU Directive is as follows:

| | Typical content (%) | | |
|---|---|---|---|
| Fat | POP | POS | SOS |
| Palm oil | 25 | 3 | trace |
| Illipé | 9 | 29 | 42 |
| Shea | 1 | 6 | 30 |
| Kokum | trace | 5 | 74 |
| Mango kernel | 1 | 13 | 41 |
| Sal | 2 | 11 | 48 |

The similarity between the six permitted fats and cocoa butter ensures that they also have similar crystallization characteristics, which is important for the successful production of solid chocolate confectionery.

However, there are some obvious differences between individual vegetable fats. For instance, palm oil contains just a trace of the SOS triacylglycerol, but is rich in the POP triacylglycerol. The other five oils each contain a much higher content of the SOS triacylglycerol than cocoa butter, yet have a much lower POP triacylglycerol content.

For improving the suitability of the permitted fats in confectionery, in particular for the production of cocoa butter equivalent fats (CBEs), some of them are modified by fractionation to obtain fractions with an increased content of the desired triacylglycerols. This is shown in the following table which compares cocoa butter with typical triacylglycerol compositions of fractions of the six permitted fats in the form in which they are commonly employed in the production of CBEs. Under the EU Directive, these fats are considered as CBEs whether used as such or in blends.

| | Typical content (%) | | |
|---|---|---|---|
| Fat | POP | POS | SOS |
| Cocoa butter | 16 | 38 | 23 |
| Palm mid-fraction | 57 | 11 | 2 |
| Illipé butter | 9 | 29 | 42 |
| Shea stearin | 3 | 7 | 73 |
| Kokum butter | trace | 5 | 74 |
| Mango kernel stearin | 2 | 13 | 55 |
| Sal stearin | 2 | 11 | 55 |

Even though vegetable oils may be enriched with the desired or required symmetrical mono-unsaturated triacylglycerols by other modification processes such as hydrogenation and interesterification, under the EU Directive, vegetable oils that are allowed in chocolate can only be obtained by refining and/or fractionation.

Chocolate products, or confectionery, are composed of fats or fatty substances such as cocoa butter in which there are dispersed non-fat products such as cocoa components, sugars, proteins (in particular, milk proteins). Other optional components include vegetable fat, any edible substance such as fruits, nuts, etc., lecithin, aromas, and flavours. The main phase of chocolate is composed of fat bodies and its melting temperature is generally not high. For example, when this phase essentially consists of cocoa butter, it starts softening at around 28° C. with concomitant loss of strength of the whole mass. The mass then no longer “breaks” in a neat manner, but rather tends to flow and sticks to the wrapping paper. In addition, after re-cooling, the mass tends to form crystallized cocoa butter (“blooming”) on its surface having a white and unpleasant appearance (“like mould”).

In order to allow developing confectionery formulations having a higher temperature resistance, which are less prone to stick to packaging or fingers, and which maintain the desired flavour, texture, mouthfeel and other characteristics of chocolate-like products, cocoa butter improvers (CBIs) have been used, in addition to or partly replacing cocoa butter. To date, CBI has been used only in small amounts of up to a maximum level of 5% of chocolate mass, calculated on legal base (as defined by the EU Directive), to improve hardness of some softer qualities of cocoa butter or to improve fat bloom resistance of chocolate products. If used with cocoa butter equivalent fats, i.e., CBEs, in producing chocolate-like confectionery coatings, a maximum of 30% of CBI has been used in CBI/CBE mixtures. Current industry practice for heat resistant compounds is the use of cocoa butter replacers (CBRs) because they do not require tempering prior to moulding or coating and are, therefore, easier to process. Yet, CBR-based confectionery has a different, more waxy mouthfeel which is less desired from a sensory aspect. Typically, the CBRs used in this application have high amounts, e.g., 40-60%, of trans-fatty acids, which are less desired from a dietary point of view, contrary to the CBE/CBI-based confectionery which has no trans-fatty acids.

The present invention provides confectionery products (especially chocolate products according to the European Union (EU) Chocolate Directive or chocolate-like products) which have a high resistance to elevated temperature and, thus, are less prone to stick to packaging and fingers, while maintaining the desired flavour, texture, mouthfeel, and the like.

### SUMMARY OF THE INVENTION

It has been found by the present inventors that the use of a high ratio of cocoa butter improver (CBI) allows overcoming the deficiencies of prior art products, in particular the insufficient heat resistance, and solves the object of the invention. The present invention, therefore, provides a confectionery product comprising cocoa butter improver (CBI) at 50% by weight or more of added vegetable fat. Moreover, the invention provides for the use of CBI in the production of confectionery products comprising CBI at a ratio of 50% by weight or more of added vegetable fat. In particular, in accordance with the invention, a heat resistant compound or composition comprising 50% by weight or more of CBI of added vegetable fat is used for coating or moulding confectionery products or used as a component of the confectionery products.

The total amount of added vegetable fat in the confectionery product, component, or coating for a confectionery product is usually in the range conventionally used, for example in general in the range of 25-40%, preferably in the range of 28-35%, added vegetable fat in the recipe for the heat resistant component. As one of ordinary skill in the art will realize, vegetable fat in the present invention may be added as vegetable fat per se (i.e., added vegetable fat) or may also be introduced via other components (e.g., cocoa butter, cocoa liquor, and the like) which are included in the heat resistant composition. If the amount of vegetable fat introduced through such other components is taken into account, the ranges of added vegetable fat given above will generally correspond to about 25-46%, preferable 30 to 40%, vegetable fat wherein such vegetable fat is equal to the sum of the added vegetable fat and the vegetable fat from such other components (i.e., total vegetable fat independent of source) in the heat resistant composition.

### DETAILED DESCRIPTION

In the present invention, CBI is used at a ratio of 50% by weight or more of added vegetable fat, up to 100% of CBI. In certain embodiments of the invention, CBI constitutes 60% or more, or 70%, or 80%, or 90%, or 100% of the added vegetable fat amount. In the present invention, the other part of added vegetable fat is one or more of CBE, cocoa butter and CBR. CBR is preferably used at not more than 10% by weight of added vegetable fat, preferably not more than 6%, or not more than 5%, more preferably not more than 2%. In one embodiment of the invention, no CBR is used at all. CBE and cocoa butter make up the remainder of the total vegetable fat. While CBE and cocoa butter can be used interchangeably, it is preferred to use CBE over cocoa butter owing to the higher costs of cocoa butter. In particular, CBE, or cocoa butter or a mixture of CBE and cocoa butter, can constitute up to 50% by weight of vegetable fat. In view of the proportion of vegetable fat contributed by CBI, CBE (or cocoa butter or a mixture of CBE and cocoa butter) can be used at up to 40% by weight, up to 30% by weight, up to 20% by weight, or up to 10% by weight of the vegetable fat, or can be absent.

Cocoa butter equivalent (CBE) is a vegetable fat composed of symmetrical 2-oleo-disaturated triacylglycerols of C16 and C18 fatty acids. CBE is a non-hydrogenated fat produced from palm kernel fat and exotic fats by means of fractionation and serves as a direct substitute for cocoa butter. Examples of CBE that can be used either alone or admixed are: palm oil fractions, illipébutter, shea stearin, kokum butter, mango kernel stearin, and sal stearin.

Cocoa butter improver (CBI) is a harder version of CBE due to the content of triacylglycerol containing stearic-oleic-stearic (SOS) acids. CBI is a non-hydrogenated fat produced from palm kernel fat and exotic fats. It is usually used in chocolate formulations having a high content of milk fat or those meant for tropical climates. It improves the heat stability of soft cocoa butter varieties, adds more solid fat and thereby increases hardness in systems having a high milk fat content.

Examples of CBIs that can be used either alone or admixed are palm or shea based and can have the following solid fat content (SFC):

Solid fat content as function of temperature

| | Ex. CBI #1 | Ex. CBI #2 |
|---|---|---|
| SFC at 20° C.: | 86% | 92% |
| SFC at 25° C.: | 86% | 91% |
| SFC at 30° C.: | 83% | 89% |
| SFC at 35° C.: | 70% | 75% |
| SFC at 40° C.: | 5% | 9% |

An exemplary range of solid fat contents is as follows:
SFC at 20° C.: 86-96%,
SFC at 25° C.: 83-93%,
SFC at 30° C.: 82-92%,
SFC at 35° C.: 69-79%, and
SFC at 40° C.: 5-12%.

An exemplary CBI is represented by PALMY® 160 CG from Fuji Oil.

A cocoa butter replacer (CBR) is a non-tempering fat differing in composition from cocoa butter and the tempering CBE and CBI. CBR is produced by fractionation and hydrogenation of oils rich in C16 and C18 fatty acids. Coatings formulated with these fats are characterized by a somewhat waxy taste, but show very good gloss. Examples of CBR that can be used either alone or admixed have typically the following solid fat content (SFC):
SFC at 20° C.: 66-78%,
SFC at 25° C.: 53-63%,
SFC at 30° C.: 31-43%,
SFC at 35° C.: 11-22%, and
SFC at 40° C.: 0-6%.

A compound of the present invention comprising CBI at 50% by weight or more of added vegetable fat can be used for moulding confectionery products, or it can be used as a component of the confectionery product, or it can be used for coating confectionery and other products, such as dragees, pralines, tablets, bars, confectionery centers (fondant, jelly, foamed, deposited), wafers, candied fruit, nuts, biscuit, granola type or cereal centers.

The compound can comprise, apart from the CBI component, any substances that are conventionally used in confectionery products, for example, cocoa powder, sugar, milk powder, dairy ingredients (including lactose and sweet whey powder), emulsifiers and vanillin. These substances are employed in the amounts and proportions in which they are conventionally used, for example sweetening agents (i.e., sugar, lactose, glucose monohydrate) 38-48%, cocoa powder 10-15%, and dairy powders (i.e., whole milk powder, skimmed milk powder, whey derivatives) 10-15%.

The manufacturing process of a confectionery product with 50% or more CBI of the added fat, in the coating, will usually be adapted in terms of temperature ranges used for tempering the coating. Typically, the optimum temperatures for the application are higher than for regular chocolate or CBE based compound.

The following examples are intended to illustrate the invention and not to limit it. Unless noted otherwise, all percentages are by weight.

### EXAMPLES

A compound or composition was produced using 90% by weight of shea based CBI and 10% by weight of palm and shea based CBE. The CBI had the following profile:
SFC at 20° C.: 92%,
SFC at 25° C.: 91%,
SFC at 30° C.: 89%,
SFC at 35° C.: 75%, and
SFC at 40° C.: 9%.
   In one trial, the following other substances were used:

sweetening agents

(i.e., sugar, lactose): 42%

cocoa powder: 14%,

dairy powders (i.e., skimmed

milk powder, whey powder): 8%,

emulsifiers, vanillin.

In another trial, the following substances were used:

sweetening agents

(i.e., sugar, lactose): 44%,

cocoa powder: 14%

dairy powders (i.e., whole milk

powder, sweet whey powder): 10%

emulsifiers, vanillin.

Another compound was produced using 70% by weight of CBI and 30% by weight of CBE. Another compound was produced using 50% by weight of CBI and 50% by weight of CBE. Another compound was produced using sugar, 100% of CBI as added vegetable fat, cocoa powder, milk powder, lactose, sweet whey powder, emulsifiers, and vanillin using the recipes above.

In the trials, the temperatures used were 5-8° C. higher than for a chocolate mass or for a compound coating with 30% CBI of the added vegetable fat.

When the 50% CBI+50% CBE compound was used for coating on wafer sticks, the resulting product was resistant to temperatures up to 32° C. for several days, without smearing or sticking to the packaging.

When the 100% CBI compound was used for coating on wafer sticks, the resulting product was resistant to temperatures up to 35° C. for several days, without smearing or sticking to the packaging.

1. A confectionery product comprising a heat resistant confectionery component, wherein the heat resistant confectionery component comprises cocoa powder, vegetable fat, and sweetener, wherein the vegetable fat comprises at least 50 percent by weight cocoa butter improver, 0 to 50 percent by weight cocoa butter equivalent, and 0 to 10 percent by weight cocoa butter replacer; wherein the cocoa butter improver has a solid fat content of
86 to 96 percent at 20° C.,
83 to 93 percent at 25° C.,
82 to 92 percent at 30° C.,
69 to 79 percent at 35° C., and
5 to 12 percent at 40° C.;
wherein the vegetable fat is at a level of about 25 to about 46 percent by weight based on the total weight of the heat resistant confectionery component; and wherein the confectionery product can be packaged in packaging material and then stored at 32° C. without the heat resistant confectionery component sticking to the packaging material.

2. The confectionery product of claim 1, wherein the vegetable fat is at a level of about 30 to about 40 percent by weight based on the total weight of the heat resistant component.

3. The confectionery product of claim 1, wherein the vegetable fat comprises at least 70 percent by weight cocoa butter improver, a non-zero amount up to 30 percent by weight cocoa butter equivalent, and 0 to 5 percent by weight cocoa butter replacer.

4. The confectionery product of claim 2, wherein the vegetable fat comprises at least 70 percent by weight cocoa butter improver, a non-zero amount up to 30 percent by weight cocoa butter equivalent, and 0 to 5 percent by weight cocoa butter replacer.

5. The confectionery product of claim 3, wherein cocoa butter improver is based on shea or palm oil.

6. The confectionery product of claim 4, wherein cocoa butter improver is based on shea or palm oil.

7. The confectionery product of claim 1, wherein the vegetable fat consists essentially of at least 50 percent by weight cocoa butter improver, 0 to 50 percent by weight cocoa butter equivalent, and 0 to 10 percent by weight cocoa butter replacer.

8. The confectionery product of claim 1, wherein the vegetable fat consists essentially of at least 70 percent by weight cocoa butter improver, a non-zero amount up to 30 percent by weight cocoa butter equivalent, and 0 to 5 percent by weight cocoa butter replacer.

9. A confectionery product comprising a heat resistant confectionery coating and a confectionery core, wherein the heat resistant confectionery coating comprises cocoa powder, vegetable fat, and sweetener, wherein the vegetable fat comprises at least 50 percent by weight cocoa butter improver, 0 to 50 percent by weight cocoa butter equivalent, and 0 to 10 percent by weight cocoa butter replacer; wherein the cocoa butter improver has a solid fat content of
86 to 96 percent at 20° C.,
83 to 93 percent at 25° C.,
82 to 92 percent at 30° C.,
69 to 79 percent at 35° C., and
5 to 12 percent at 40° C.;
wherein the vegetable fat is at a level of about 25 to about 46 percent by weight based on the total weight of the heat resistant confectionery coating; and wherein the confectionery product can be packaged in packaging material and then stored at 32° C. without the heat resistant confectionery coating sticking to the packaging material.

10. The confectionery product of claim 9, wherein the vegetable fat in the heat resistant confectionery coating is at a level of about 30 to about 40 percent by weight based on the total weight of the heat resistant confectionery coating.

11. The confectionery product of claim 9, wherein the vegetable fat in the heat resistant confectionery coating comprises at least 60 percent by weight cocoa butter improver, a non-zero amount up to 30 percent by weight cocoa butter equivalent, and 0 to 5 percent by weight cocoa butter replacer.

12. The confectionery product of claim 10, wherein the vegetable fat in the heat resistant confectionery coating comprises at least 70 percent by weight cocoa butter improver, a non-zero amount up to 30 percent by weight cocoa butter equivalent, and 0 to 5 percent by weight cocoa butter replacer.

13. The confectionery product of claim 11, wherein cocoa butter improver in the heat resistant confectionery coating is based on shea or palm oil.

14. The confectionery product of claim 12, wherein cocoa butter improver in the heat resistant confectionery coating is based on shea or palm oil.

15. The confectionery product of claim 9, wherein the vegetable fat in the heat resistant confectionery coating consists essentially of at least 50 percent by weight cocoa butter improver, 0 to 50 percent by weight cocoa butter equivalent, and 0 to 10 percent by weight cocoa butter replacer.

16. The confectionery product of claim 9, wherein the vegetable fat in the heat resistant confectionery coating consists essentially of at least 70 percent by weight cocoa butter improver, a non-zero amount up to 30 percent by weight cocoa butter equivalent, and 0 to 5 percent by weight cocoa butter replacer.
